(19) United States
(12) Patent Application Publication
(10) Pub. No.: US 2014/0113241 A1
(43) Pub. Date: Apr. 24, 2014

(54) CALCINING KETTLE

(71) Applicant: UNITED STATES GYPSUM COMPANY, Chicago, IL (US)

(72) Inventor: Donald E. Rooks, JR., Rinsselaer, IN (US)

(73) Assignee: UNITED STATES GYPSUM COMPANY, Chicago, IL (US)

(21) Appl. No.: 13/657,243

(22) Filed: Oct. 22, 2012

(51) Int. Cl. C04B 7/44; F27B 1/10

(52) U.S. Cl. 432/98

(57) ABSTRACT

A calcining kettle includes a cylindrical housing having a hot air chamber at one end, a dust collecting chamber at an opposite end and a calcining chamber between the hot air chamber and the dust collecting chamber, at least one air pad disposed between the hot air chamber and the calcining chamber, each air pad being supported by air pad supports for passage of hot air therethrough. At least one rake is disposed within the calcining chamber and configured for rotation about a vertical axis, the at least one rake stirring gypsum located adjacent to the at least one air pad. A plurality of burners is located within the calcining chamber and displaced from the air pad and the at least one rake in a direction toward the dust collecting chamber. The burners being disposed within a bed of gypsum that is heated by the burners for calcining the gypsum.

### FIELD OF THE INVENTION

This invention relates to an improved apparatus for calcining gypsum. More specifically, the present calcining apparatus features an internal agitator.

### BACKGROUND

Gypsum is also known as calcium sulfate dihydrate, terra alba or landplaster. Synthetic gypsum, which is a byproduct of flue gas desulfurization processes from power plants, is another source of dihydrate gypsum. Plaster of Paris is also known as calcined gypsum, stucco, calcium sulfate semihydrate, calcium sulfate half-hydrate or calcium sulfate hemihydrate. It is the hemihydrate form that is mixed with water, then shaped to form a product having an interlocking matrix of gypsum crystals. When it is mined, raw gypsum is generally found in the dihydrate form. In this form, there are approximately two water molecules of water associated with each molecule of calcium sulfate. In order to produce the hemihydrate form, the gypsum is calcined to drive off some of the water of hydration by the following equation:

CaSO₄.2H₂O→CaSO₄.1/2H₂O+3/2H₂O

Gypsum hydration occurs in a matter of minutes or hours compared to several days for cement. This makes gypsum an attractive alternative for many applications where sufficient hardness and strength can be achieved by using gypsum.

There are many ways known to calcine gypsum. U.S. Pat. Nos. 5,743,954; 5,927,968; 5,743,728 and 5,954,497 disclose calcining devices having cylindrical kettles with submerged heat exchangers and rotary stirrers.

U.S. Patent Application Publication No. 2010/0059204 describes a calciner using submerged heat exchange tubes. The heat exchange tubes are provided with a heated gas, such as a flue gas or superheated steam. Fluidizing gas is provided to the calciner but the source of the gas is not identified.

With regard to burner exhaust being recirculated to provide fluidization, note particularly Watkins, et al., U.S. Pat. No. 4,455,285 and U.S. Pat. No. 4,919,613. Both patents disclose a calcinations device having a central combustion chamber providing heat to solids by exchange through the chamber side walls. Exhaust from the combustion chamber is conveyed from the top of the chamber, downward to plenum chambers and into sparge pipes in the lower regions of the calcining chambers.

Also note U.S. Pat. No. 5,139,749, providing a fluidized calcining process in which burner exhaust passes through submerged heat exchangers and part of the burner exhaust is cycled through an incoming conveyor to fluidize particles being supplied to the calcining kettle.

Note is also made of Bolind, et al., U.S. Pat. No. 7,121,713; U.S. Pat. No. 7,175,426 and U.S. Pat. No. 7,434,980, disclosing calcining kettles with submerged heat exchangers fired by burners with the exhaust being directed to a space below a fluidizing pad from where the exhaust flows upward through the pad and through the solids being fluidized. A vibrating agitator is provided above the fluidizing pad and the heat exchange structure is mounted for removal from the kettle permitting repair or replacement.

### SUMMARY

An improved calcining kettle is provided, employing exhaust from burners for fluidizing the calcined solids and removing the solids from the kettle. A cylindrical housing allows the use of a rotary rake for stirring solids at the bottom of the kettle. The kettle is divided into four quadrants, with a burner in each quadrant providing heated exhaust to heat exchangers embedded in the solids being calcined. Exhaust from the burners passes through the heat exchangers and is then conveyed to a hot air chamber at the bottom of the kettle below fluidization pads where it then travels through the pads and the solids being calcined, providing a fluidization flow for the solids. Blowers are optionally provided for maintaining a desired flow rate.

More specifically, a calcining kettle includes a cylindrical housing having a hot air chamber at one end, a dust collecting chamber at an opposite end and a calcining chamber between the hot air chamber and the dust collecting chamber, at least one air pad disposed between the hot air chamber and the calcining chamber, each air pad being supported by air pad supports for passage of hot air therethrough. At least one rake is disposed within the calcining chamber and configured for rotation about a vertical axis, the at least one rake stirring gypsum located adjacent to the at least one air pad. A plurality of burners is located within the calcining chamber and displaced from the air pad and the at least one rake in a direction toward the dust collecting chamber. The burners being disposed within a bed of gypsum that is heated by the burners for calcining the gypsum.

### BRIEF DESCRIPTION OF THE DRAWINGS

FIG. 1 is a front elevation of the present calcining kettle;

FIG. 2 is a cross-section taken along the line 2-2 of FIG. 1 and in the direction generally designated;

FIG. 3 is a cross-section taken along the line 3-3 of FIG. 1 and in the direction generally designated;

FIG. 4 is a cross-section taken along the line 4-4 of FIG. 1 and in the direction generally designated;

FIG. 5 is an enlarged fragmentary side elevation of the present kettle;

FIGS. 6A-C are alternate embodiments of the present rake drive motor, shown in partial section;

FIGS. 7A-D are overhead plan views of alternate embodiments of the present rake configuration;

FIGS. 8 A-C are vertical cross-sections of alternate embodiments of the present rake arms;

FIG. 9 is a fragmentary side elevation of the present rake drive system;

FIG. 10 is a fragmentary side elevation of the present rake drive system;

FIG. 11 is a vertical elevation of the present kettle;

FIG. 12 is a front elevational view of an elbow connection used in the present kettle;

FIG. 13 is a fragmentary side elevation of a forced air system for the present kettle;

FIG. 14 is a fragmentary schematic side elevation of the forced air system of FIG. 13:

FIG. 15 is a fragmentary side elevation of a support for the present heating coils;

FIG. 16 is a schematic of a first arrangement of the present burner tube assembly;

FIG. 17 is a schematic of a second arrangement of the present burner tube assembly;

FIG. 18 is a fragmentary side elevation of the present dump gate and elevator of the present kettle;

FIG. 19 is an overhead plan view of the present burner arrangement;

FIG. 20 is an overhead plan view of an alternate embodiment of the present burner arrangement;

FIG. 21 is a schematic side elevation of the present kettle depicting the burner tube pattern;

FIG. 22 is a schematic side elevation of an alternate embodiment of the present kettle depicting the burner tube pattern;

FIG. 23 is a side elevation of a tube nest of the present kettle; and

FIG. 24 is an end elevation of the tube nest of FIG. 23.

### DETAILED DESCRIPTION

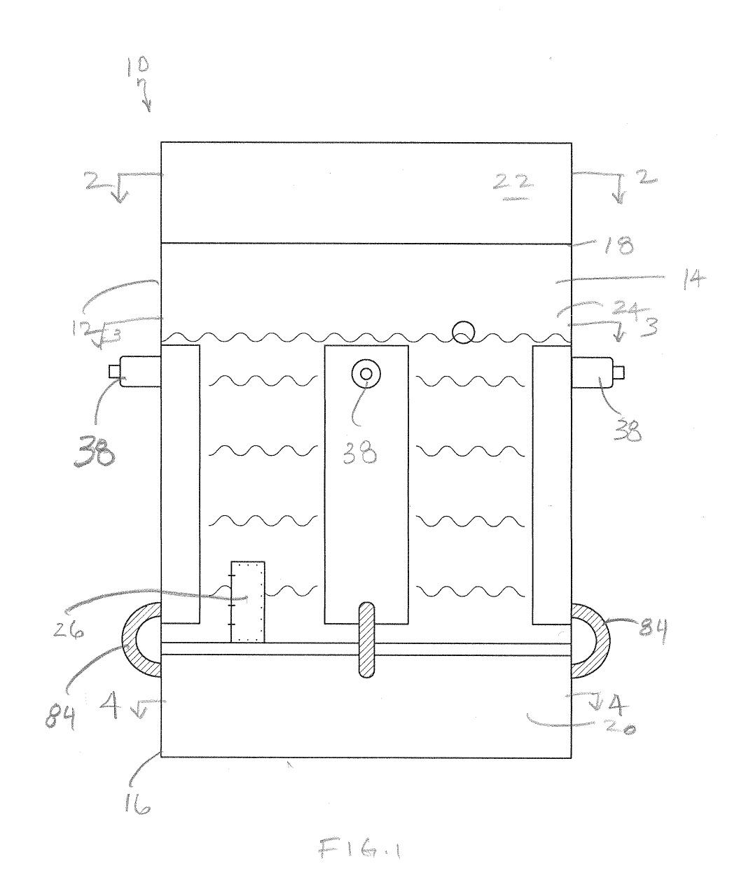

Referring to FIG. 1, an improved apparatus, generally 10, for calcining gypsum, also referred to herein as a calcining kettle, includes a housing, generally designated 12. The housing 12 includes a cylindrical wall 14 and two ends, namely, a bottom end 16 and an open top end 18. Adjacent to the bottom end 16 of the housing 12 is a hot air chamber, generally 20. At an opposing end of the housing 12 is a dust collecting chamber 22. Between the hot air chamber 20 and the dust collecting chamber 22 is a calcining chamber 24. The housing 12 is made of any material that withstands the temperatures used during calcining. Examples of suitable materials are metals, particularly stainless steel. At least one access door 26 is disposed in the housing 12 and provides access to the calcining chamber 24.

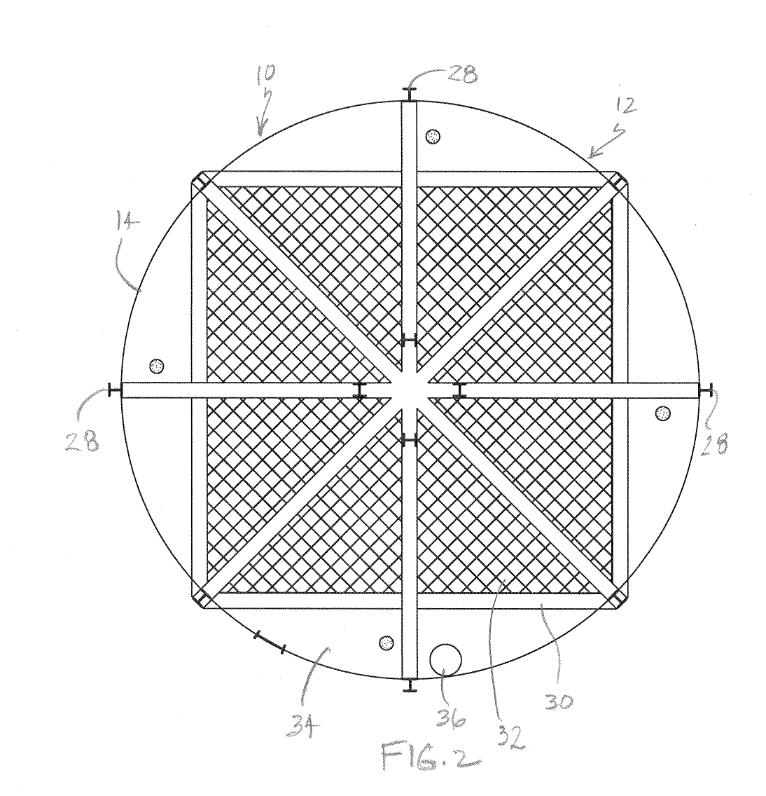

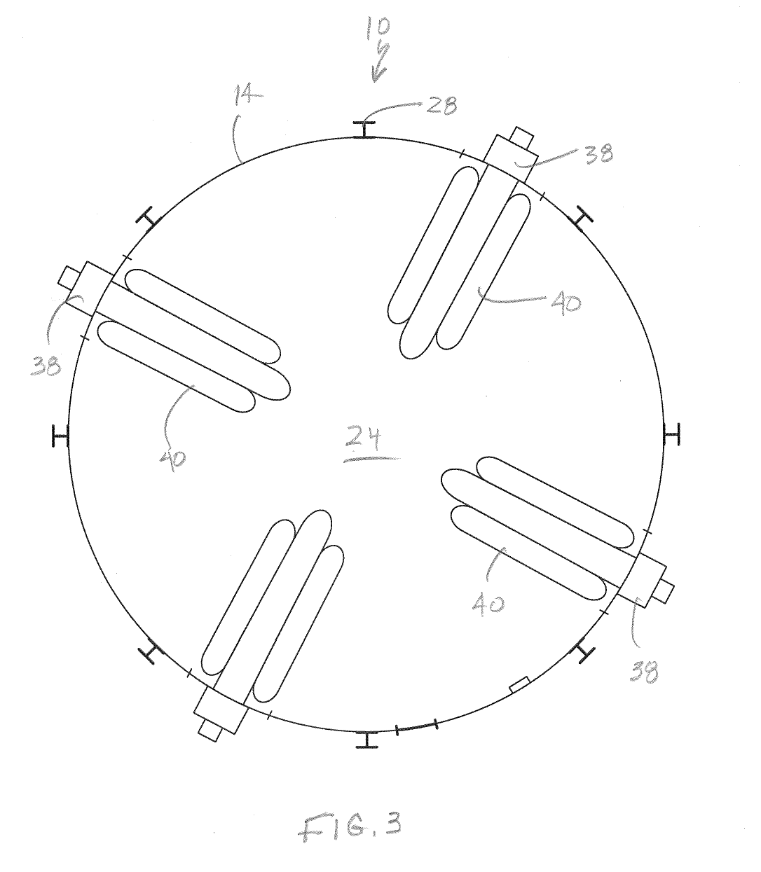

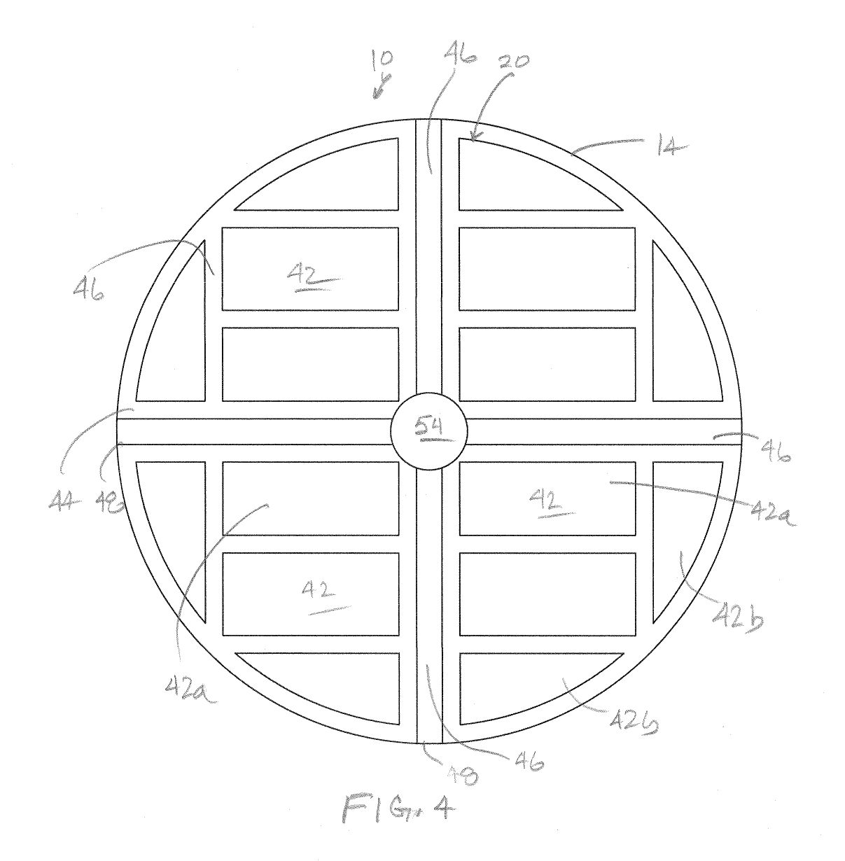

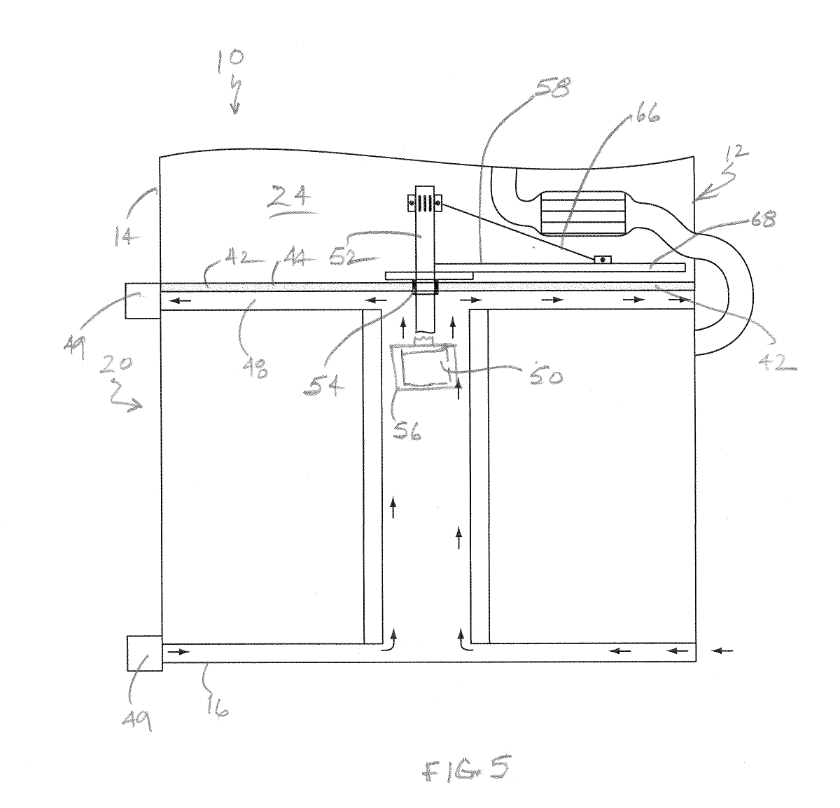

Referring to FIGS. 1 and 2, the housing 12 is supported by a plurality of vertically arranged support legs 28. As shown in FIGS. 2 and 3, the support legs 28 are optionally “I” beams. The dust collecting chamber 22 rests upon a generally rectangular, generally horizontally disposed frame 30. The frame 30 defines an open chamber 32 in which steam circulates for calcining the gypsum. A lid 34 seals the dust collecting chamber 22 from above. At least one inspection port 36 is provided in the lid 34.

Referring now to FIG. 3, a plurality of burners 38 are disposed in the housing 12 and project into the calcining chamber 24. The burners 38, typically operating in the approximate range of 7-10 million BTUs and being connected to a source of heated air, gas or the like, are each connected to burner tubes 40 for heating air in the tubes that both circulates the heat within the calcining chamber 24 and also sends heated air to the hot air chamber 20. The tubes 40 also receive combustion gas generated by the burners 38. Although the position and total length of the burner tube 40 varies depending on the desired temperatures of the hot air, the flow rate of the gypsum and a number of other process conditions, the enhanced heat transfer occurs when there is a large surface area between the hot air donating the heat and the cooler air receiving the heat. Thus, in some embodiments, the burner tube 40 takes a long and tortuous path through the calcining chamber 24 for enhancing heat exchange. Examples of the path taken by the burner tube 40 are a zigzag pattern (FIG. 17) and a fan pattern (FIG. 16).

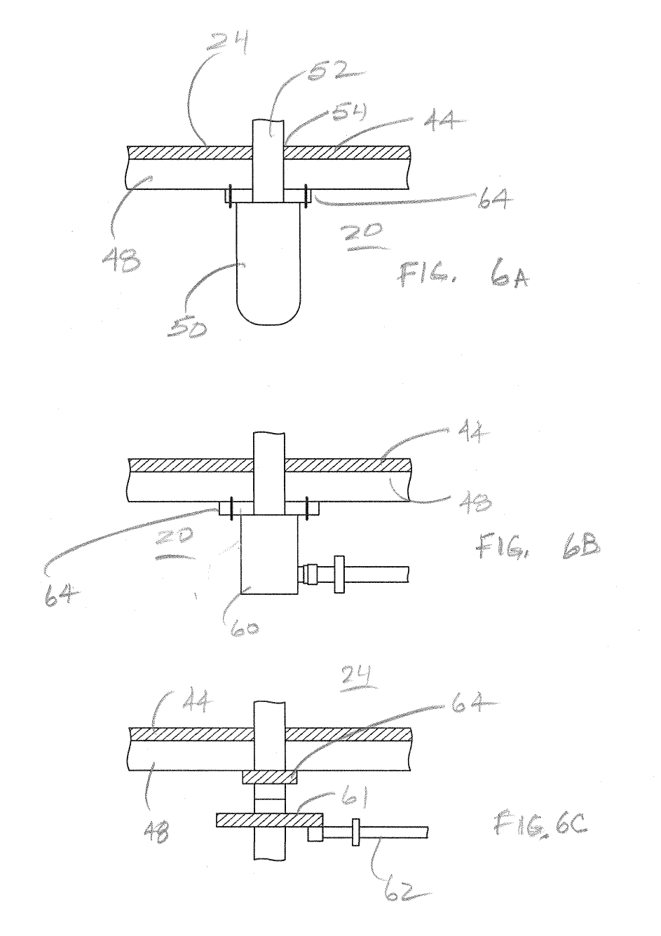

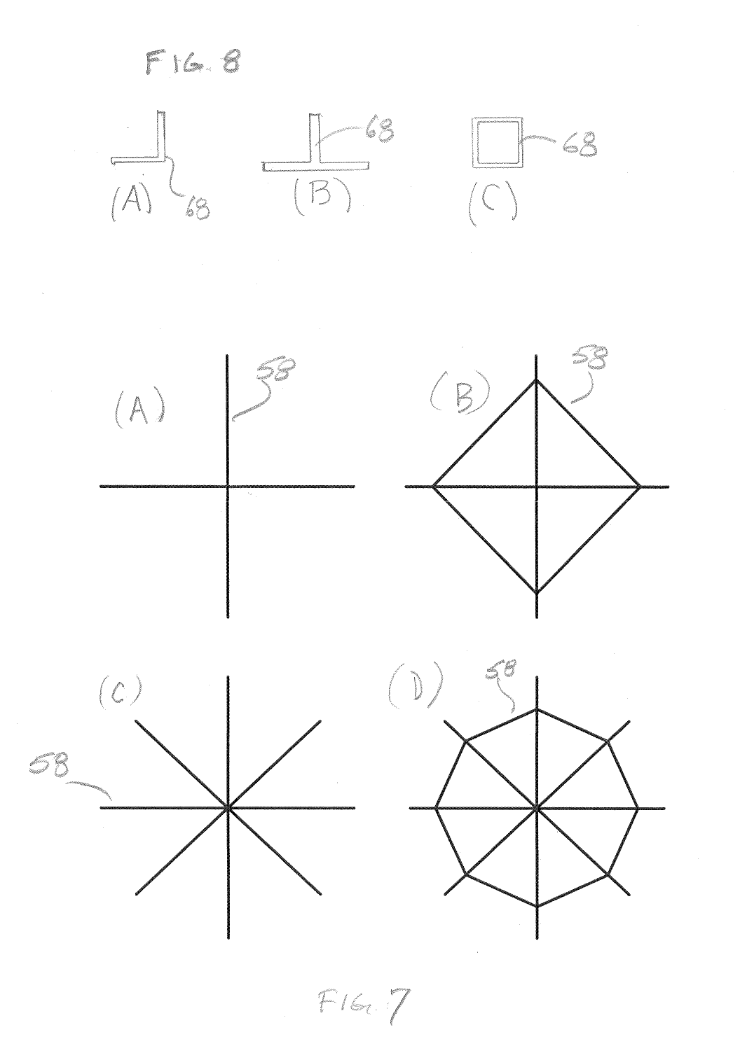

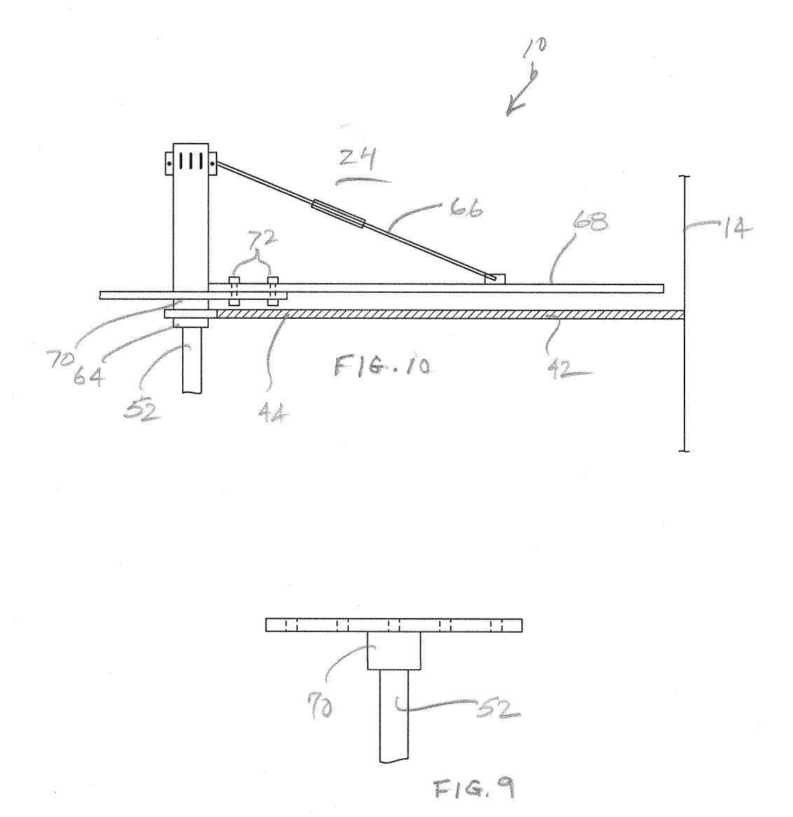

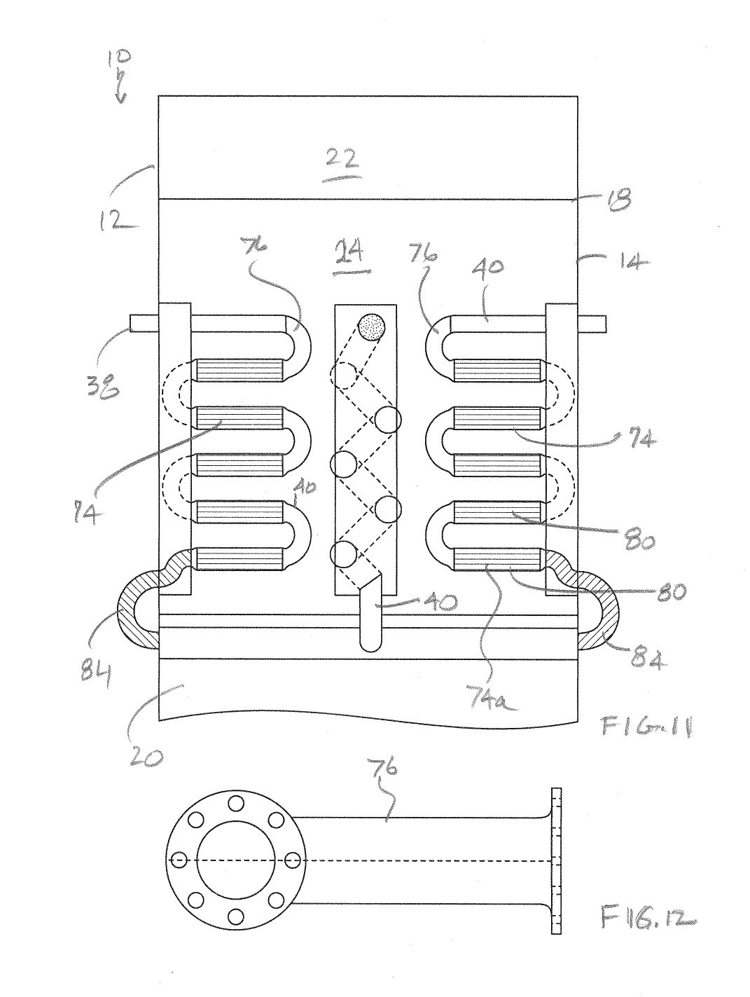

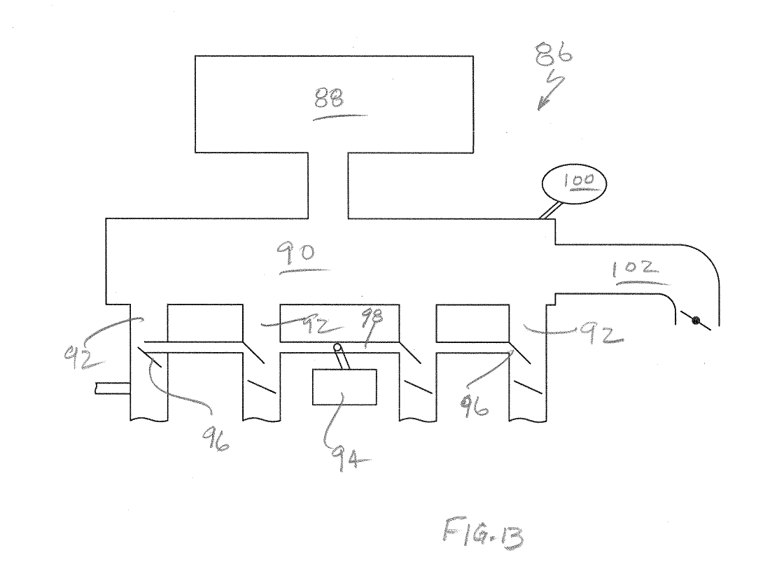

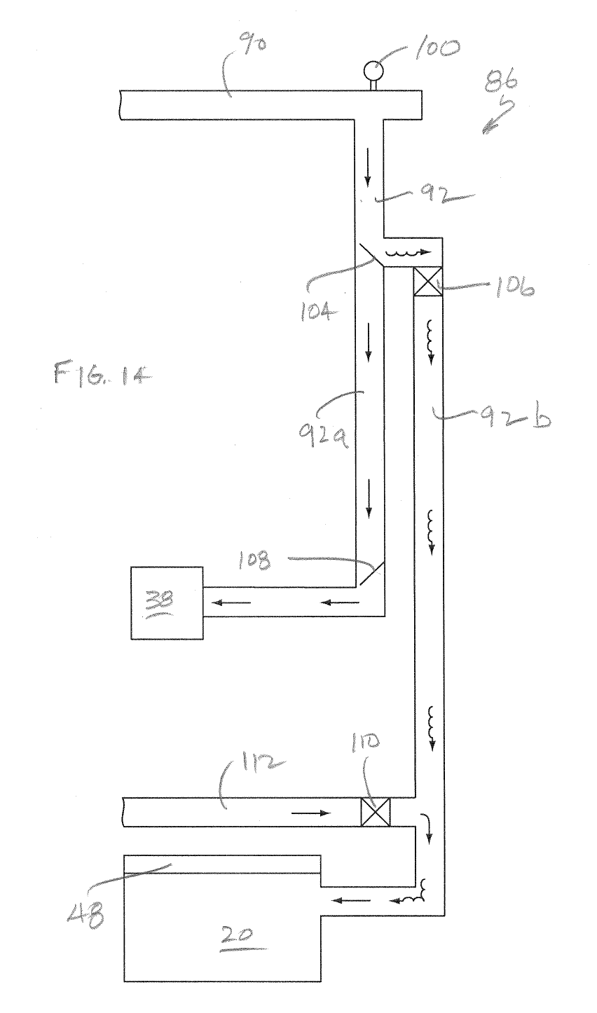

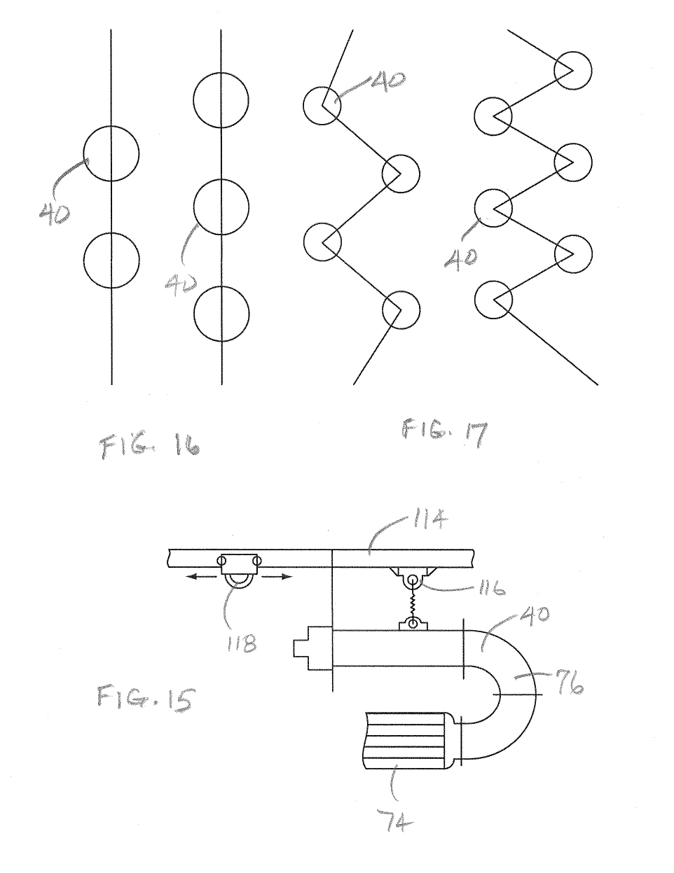

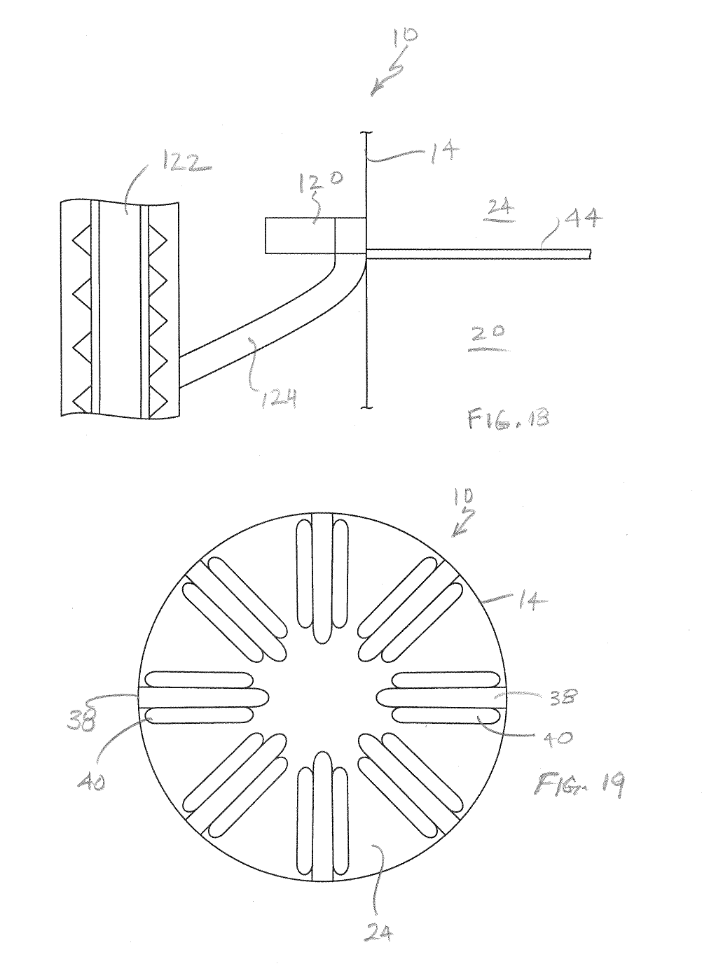

Referring now to FIG. 4, in the hot air chamber 20, a plurality of air pads 42 are disposed at the interface between the hot air chamber 20 and the calcining chamber 24 to form a platform 44 supported by air pad frame or supports 46 such as horizontally-arranged “I”-beams, “T”-beams or any other rigid support. The pads 42, made of an air-permeable material, are fastened in place, by fasteners such as bolts (not shown). The air pad supports 46 are assembled with each other to support the air platform 44 formed by the air pads 42, also called fluidization pads. Another characteristic of the air pad frame 46 is that it allows for distribution of air from the hot air chamber 20 to the fluidization pads 42. Use of I-beams for the frame 46 allows hot air to flow through channels 48 (FIG. 5) formed by the beam.

The air pad frame 46 and the fluidization pads 42 are shaped so that the fluidization pads are supported and held in place by the frame. One characteristic of the fluidization pads 42 is that they are porous to permit passage of hot air therethrough. The fluidization pads 42 can be made of any shape, however, in order to reduce the number of replacement parts that must be available, it is preferable to make the fluidization pads 42 from a select few basic shapes. In one embodiment, the fluidization pads 42 are all wedge shaped, having a wide end toward the housing wall 14 and a narrow end toward the axle 26. In another embodiment shown in FIG. 4, the fluidization pads 42 have two shapes, rectangles 42a and right triangles 42b where the hypotenuse is curved.

Referring now to FIG. 5, an enlarged side view is provided of the hot air chamber 20, which circulates hot air in the channels 48 disposed below the air pads 42. At least one fan 49 is placed in communication with the channels 48 for circulating the heated air. A rake drive motor 50 is disposed in the hot air chamber 20, preferably below the air pads 42. An axle or drive shaft 52 projects vertically through an opening 54 in the air pad platform 44. Preferably, the motor 50 is enclosed in an insulated motor housing 56 having at least one motor housing access panel (not shown) to allow servicing of the motor.

Referring now to FIGS. 5 and 6A-C, the rake drive motor 50 is connected to the axle for rotating the axle as well as at least one rake 58 with the axle 52 to turn it. Various drive systems are contemplated for driving the axle 52. In FIG. 6A, the motor 50 is an in-line type; in FIG. 6B, a right angle drive gear box 60 is connected to a horizontally arranged motor drive shaft 62. In FIG. 6C, a bull and pinion gear assembly 61 transfers drive energy from the motor drive shaft 62 to the axle 52. In all three embodiments, a seal 64 is provided for protecting the motor 50 from stucco in the calcining chamber 24 from entering the hot air chamber 20, and for retaining the hot air within the hot air chamber.

Referring now to FIGS. 5, 7A-7D, and 10, the at least one rake 58 projects laterally from the axle 52 and is optionally supported by a cable or turnbuckle 66 connected to a rake arm 68. The rake 58 is disposed within the calcining chamber 24 in spaced, parallel relationship to the air pad platform 44. Preferably, the rake 58 is close enough to the air pads 42 so that the gypsum layer on the air pad is not sufficiently deep to block not air flow from the pads 42 and thus allows the gypsum in the calcining chamber 24 to be fluidized. The length of the arm 68 varies. For efficiency, the arm 68 does not touch the wall 14 of the housing 12, but it sweeps over a large portion of an upper surface of the air pads 42 during rotation.

The arm 68 is any useful shape and is sufficiently strong to resist deformation during the act of stirring the gypsum. Strength is an important property of the rake arm 68. As seen in FIGS. 7A-7D, the rake 58 is optionally provided in a variety of patterns, including respectively “X”, star, quadrilateral and polygonal. Other shapes are contemplated provided that a rigid, rotating member is disposed in the calcining chamber for stirring the gypsum during the heating process.

Referring now to FIGS. 8A-8C, 9 and 10, each rake arm 68 has a variety of configurations depending on the application, including, but not limited to, respectively angle iron, “T’-stock and enclosed tubing. Each rake arm 68 is connected to the axle 52 using a hub 70, which provides the mounting point where the rake arm 68 is fastened to rotate with the axle, preferably using fasteners 72.

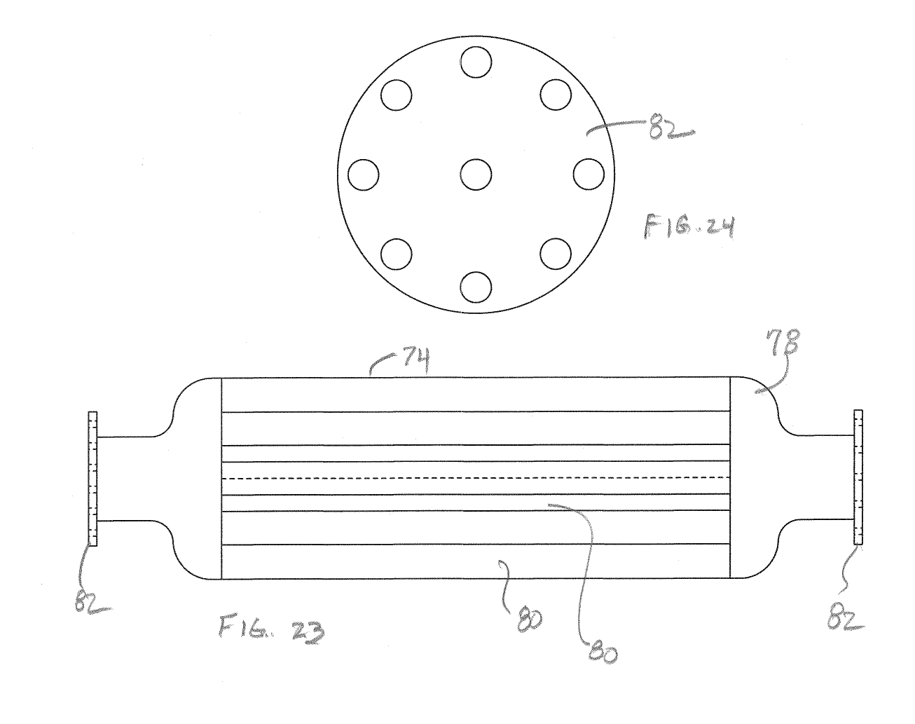

Referring now to FIGS. 11, 12, 23 and 24, for proper circulation of heat within the calcining chamber 24, the burners 38 are connected to the burner tubes 40, which include spaced tube nests 74 connected together in series by elbows 76. Each tube nest 74 includes an outer shell 78 in which are disposed several independent tubes 80, spaced from each other. The tube nests 74 are connected to the elbows 76 using flanges 82 as are well known in the art. It is preferred that all tube nests 74 are the same size pipe and length so as to be interchangeable in any location on the kettle 10. Also, if a reduction in the number of tube nests 74 is needed for changing burner back pressure, the reduction is accomplished after the tube rest farthest from the burner. Note in FIG. 11 that the last tube nest 74a is connected to a flexible conduit 84 that is in fluid communication with the air channels 48 located beneath the platform 44.

Referring now to FIGS. 16 and 17, the arrangement of the burner tubes 40 is variable in the kettle 10 depending on the manner in which the flanges 82 are bolted together. With the extensive use of the same type of tube nest 74 and elbows 76, a reduction in the variety of required spare parts is achieved for the present kettle 10.

Referring now to FIG. 13, a forced air system for the present kettle 10 is generally designated 86, and includes a blower 88 in fluid communication with a header pipe 90, which in turn is connected to several air distribution pipes 92. The latter pipes 92 pass in close proximity to the burners 38 for receiving burner exhaust and for heating the air within the pipes. An actuator 94 connected to dampers 96 in each pipe 92 through a linkage 98 controls the flow of air adjacent the dampers as desired. An optional pressure gauge 100 monitors pressure within the header pipe 90. Also connected to the header pipe 90 is an air pad conduit 102 leading to the air pads 42.

Referring now to FIG. 14, a schematic side view of the forced air system 86 illustrates how air is distributed about the kettle 10 using the air distribution pipes 92. A first valve 104 in the pipe controls air flow from the main header pipe 90 to a corresponding one of the burners 38 via a distribution pipe 92a. A second valve 106 controls air flow to the hot air chamber 20 via a distribution pipe 92b. A third valve 108 in the distribution pipe 92a prevents back flow to the header pipe 90. A fourth valve 110 located adjacent the distribution pipe 92b controls the flow of air conveyed in conduit 112 also connected to the burners 38. The valves 104, 106, 108, 110 are adjusted as needed to circulate heated air flow through the kettle 10, including the air channels 48 even when the burners 38 are not operational.

Referring now to FIG. 15, the burner tubes 40 are optionally supported from a housing frame member 114 through at least one of a fixed eyelet 116 and a movable trolley eyelet 118. The frame member 114 is optionally extended horizontally outside the housing 12 to facilitate installation or removal of burners 38 and the associated tubes 40.

Referring now to FIG. 18, the calcined gypsum produced in the kettle 10 is passed through a gate 120 in communication with an elevator 122 via a gravity fed, compressed air-enhanced conduit 124. The elevator 122 is of the type used in conventional calcining kettles.

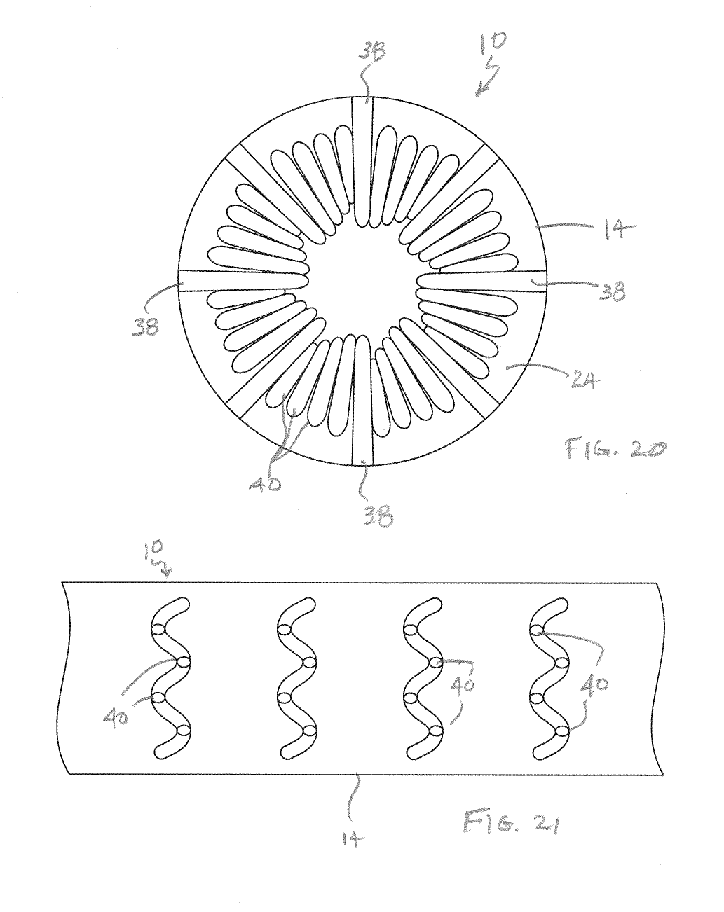

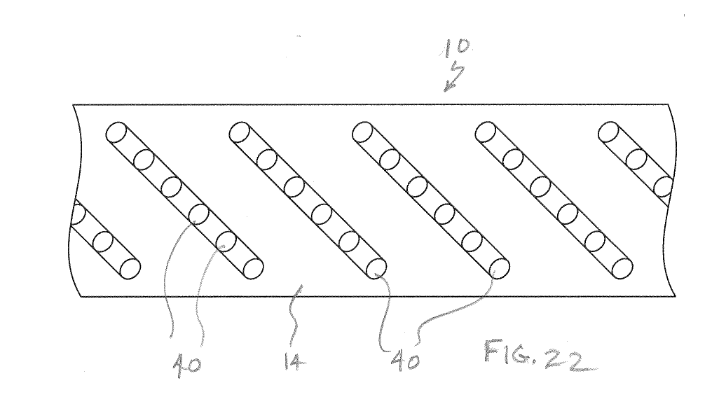

Referring now to FIGS. 19-22, various arrangements of burners 38 and burner tubes 40 are contemplated, depending on the desired heat/output range for the kettle 10. In FIGS. 19-22 an eight burner arrangement is depicted, to contrast with the four burner arrangement depicted in FIGS. 3, 11, 16 and 17. FIGS. 19 and 21 depict a zig-zag burner arrangement, while FIGS. 20 and 22 depict a fan pattern arrangement.

In operation, hot air enters the calcination chamber 24 through the air/fluidization pads 42. Gypsum, also known as calcium sulfate dihydrate, is deposited within the calcining chamber 24 as is known in the art. As the gypsum is heated by the hot air, it undergoes a change in crystal structure from the dihydrate to the hemihydrate form, releasing 1½ molecules of water from each calcium sulfate molecule. In the hot air, the water is vaporized to steam. The hot gasses, including steam and hot air, rise within the calcination chamber 24 and fluidize the calcium sulfate hemihydrate, known as calcined gypsum. The fluidized particles are carried upward to the dust collecting chamber 22, where the calcined gypsum is recovered from the hot air.

In addition, within the calcining chamber 24, the burners 38 are disposed within a bed of gypsum and take fuel and air from the exterior of the kettle 10 for combustion occurring within the calcining chamber for calcining the gypsum. The combustion exhaust is routed into the burner tubes 40 and moves countercurrent to hot air rising through the bed of gypsum to heat and fluidize the gypsum. The combustion exhaust is transferred from the calcining chamber 24 to the hot air chamber 20 adjacent the air pads 42 and returns to the calcining chamber through the air pads.

Some gypsum particles will not be entrained in the hot gasses within the calcination chamber 24. The steam may condense on the gypsum particles and they stick together due to surface tension. Larger particles or particles stuck together can fall through the hot gasses to the air pad 36. The rake 58 rotates within the calcining chamber 24, circumscribing a plane that is generally parallel to the plane of the air pad platform 44. Movement of the rake 58 stirs gypsum particles adjacent to the air pads 42. As air entering the calcining chamber 24 through the air pads 42 is somewhat drier than the hot air in the upper portion of the calcining chamber 24, the raking motion preferably breaks up particles that were once stuck together, allowing additional fluidization of the gypsum and calcined gypsum.

While particular embodiments of the present calcining kettle have been described herein, it will be appreciated by those skilled in the art that changes and modifications may be made thereto without departing from the invention in its broader aspects and as set forth in the following claims.

What is claimed is:

1. An apparatus for calcining gypsum, comprising:
a cylindrical housing having a hot air chamber at one end, a dust collecting chamber at an opposite end and a calcining chamber between said hot air chamber and said dust collecting chamber;
at least one air pad disposed between said hot air chamber and said calcining chamber, said air pad being supported by air pad supports for passage of hot air therethrough;
at least one rake disposed within said calcining chamber and configured for rotation about a vertical axis of said housing, said at least one rake stirring gypsum located adjacent to said air pad; and
a plurality of burners within said calcining chamber and displaced from said air pad and said at least one rake in a direction toward said dust collecting chamber, said burners being disposed within a bed of gypsum that is heated by the burners for calcining the gypsum.

2. The apparatus of claim 1, wherein the combustion exhaust is contained in conduits and is moved countercurrent to hot air rising through the bed of gypsum for heating and fluidizing the gypsum.

3. The apparatus of claim 1 wherein said at least one rake comprises a plurality of arms.

4. The apparatus of claim 2 wherein said at least one rake comprises from 4 to eight arms, inclusive.

5. The apparatus of claim 1 wherein each arm of said rake further comprises a support, said support being attached to said arm and to an axle rotating said arm.

6. The apparatus of claim 1 wherein each said rake has a cross-section that is L-shaped, T-shaped or polygonal.

7. An apparatus for calcining gypsum, comprising:
a cylindrical apparatus having a wall and two ends, a hot air chamber at one said end, a dust collecting chamber at an opposing end of said apparatus and a calcining chamber between said hot air chamber and said dust collecting chamber;
said hot air chamber having a motor for rotating an axle, said axle extending from said hot air chamber into said calcining chamber and being parallel to said wall of said cylindrical apparatus;
an air pad at an interface of said hot air chamber with said calcining chamber, said air pad being supported by air pad supports and including an opening for passage of said axle therethrough and further including fluidization pads for passage of hot air therethrough;
a rake within said calcining chamber attached to and driven by said axle radially around said cylindrical apparatus, said rake stirring the gypsum adjacent to said air pad; and
a plurality of burners within said calcining chamber parallel to said wall of said apparatus and displaced from said air pad and said rake in a direction toward said dust collecting chamber, said burners being disposed within a bed of gypsum that is heated by the burners for calcining the gypsum, the burners generating combustion exhaust that is transferred from said calcining chamber to said hot air chamber around said associated air pad section and returning to said calcining chamber through said fluidization pads.
